(19) United States
(12) Patent Application Publication
(10) Pub. No.: US 2011/0192920 A1
(43) Pub. Date: Aug. 11, 2011

(54) ELECTROSTATIC ATOMIZATION DEVICE FOR VEHICLE PASSENGER COMPARTMENT

(75) Inventors: Shinjirou Seto, Hikone (JP); Takeshi Yano, Kyoto (JP)

(73) Assignee: PANASONIC ELECTRIC WORKS CO., LTD., OSAKA (JP)

(21) Appl. No.: 13/123,400

(22) PCT Filed: Oct. 23, 2009
(86) PCT No.: PCT/JP2009/068632

§ 371 Date: Apr. 8, 2011

(30) Foreign Application Priority Data
Oct. 24, 2008 (JP) 2008-274732

(51) Int. Cl. B05B 5/00

(52) U.S. Cl. 239/690

(57) ABSTRACT

An in-vehicle compartment electrostatic atomization device (A) for use in the passenger compartment of a vehicle. The in-vehicle compartment electrostatic atomization device (A) includes water supply unit (4) and a discharge electrode (2) which applies high voltage to water supplied from the water supply unit (4) to electrostatically atomize the water and generate electrostatically charged atomized water droplets (M). A housing (15) is formed integrally with an illumination device (B) arranged in a ceiling (14) of the passenger compartment above a front seat (13) of the vehicle. The in-vehicle compartment electrostatic atomization device (A) shares the housing (15) with the illumination device (B) so as to be arranged near the head of a vehicle occupant (H) seated on the front seat (13).

### TECHNICAL FIELD

The present invention relates to an in-vehicle compartment electrostatic atomization device that supplies electrostatically charged atomized water droplets to a vehicle passenger compartment.

### BACKGROUND ART

In a vehicle such as an automobile, the odor of cigarettes or the like may remain in the vehicle, especially, in the passenger compartment. In the prior art, a filter type air purifier is used in vehicles to eliminate such an odor. The filter type air purifier draws air from the passenger compartment through a filter to purify the air. The air purifier then returns the purified air to the passenger compartment. However, this air purifier cannot eliminate odorous components that have been caught in the walls, seats, and the like of the passenger compartment.

An electrostatic atomization device that has recently been drawing attention electrostatically atomizes water to generate electrostatically charged atomized water droplets. The electrostatically charged atomized water droplets generated by the electrostatic atomization device include radicals, such as hydroxyl and superoxide radicals. Thus, in addition to having a deodorizing effect, the electrostatically charged atomized water droplets have a deactivating effect on allergens. The electrostatically charged atomized water droplets, when delivered into the passenger compartment, deodorize the odorous components caught in the walls, seats, and the like in addition to the odorous components suspended in the air. The electrostatically charged atomized water droplets also function to deactivate allergens such as dead mites or pollen. Dead mites may be caught in the seats, floor carpet, cushions, and the like. Pollen may enter the passenger compartment when opening and closing the doors. Pollen may also enter the passenger compartment when collected on the clothes of a person who enters the passenger compartment.

One type of an electrostatic atomization device is arranged in an air duct of a vehicle air conditioner between an air inlet and an air outlet so that the electrostatically charged atomized water droplets generated by the electrostatic atomization device are discharged into the passenger compartment by the air current produced by the air conditioner (for example, refer to Japanese Laid-Open Patent Publication No. 2006-151046).

In addition to the deodorizing and allergen deactivating effect, it is known that the electrostatically charged atomized water droplets generated by the electrostatic atomization device has an effect for improving human hair quality (flexibility, tensility, lustrousness, etc.)

### DISCLOSURE OF THE INVENTION

However, in a structure in which an electrostatic atomization device is arranged in an air conditioner duct, electrostatically charged atomized water droplets collect on the interior walls of the air duct. As a result, the amount of electrostatically charged atomized water droplets discharged into the passenger compartment from the air outlet of the air conditioner becomes relatively small. The amount of electrostatically charged atomized water droplets suspended in the air current produced by the air conditioner and reaching the vehicle occupant's hair further decreases.

It is an object of the present invention to provide an in-vehicle compartment electrostatic atomization device that enhances the effect for improving the vehicle occupant's hair quality in comparison with the prior art.

One aspect of the present invention is an in-vehicle compartment electrostatic atomization device arranged in a passenger compartment of a vehicle. The in-vehicle compartment electrostatic atomization device includes a water supply unit for supplying water. A discharge electrode applies high voltage to water supplied from the water supply unit to electrostatically atomize the water and generate electrostatically charged atomized water droplets. A housing is formed integrally with an illumination device arranged in a ceiling of the passenger compartment above a front seat of the vehicle.

In this structure, the in-vehicle compartment electrostatic atomization device is arranged near the head of a vehicle occupant seated in the front seat. In comparison with when an electrostatic atomization device is arranged in an air conditioner duct, the amount of electrostatically charged atomized water droplets that reaches the vehicle occupant's hair is drastically increased. This enhances the hair quality improvement effect of the electrostatically charged atomized water droplets. Further, the illumination device arranged in the ceiling above the front seat is suitable for providing illumination for the vehicle occupant seated on the front seat. The illumination device, which is used by the driver or a vehicle occupant seated in the front passenger seat, for example, to read a map during the nighttime, is often installed in automobiles. Thus, the arrangement of the in-vehicle compartment electrostatic atomization device according to the present invention would not affect the appearance of the passenger compartment.

In one example, the vehicle includes an air current generation device which generates an air current flowing toward the rear along the ceiling in the passenger compartment from an air outlet arranged in front of the front seat. Further, the housing is arranged toward the rear of the air outlet of the air current generation device in a path of the air current.

In this structure, by using the air current, the electrostatically charged atomized water droplets reaches deep into the vehicle occupant's hair. This further enhances the hair quality improvement effect of the electrostatically charged atomized water droplets.

In one example, the air outlet of the air current generation device is located below a front windshield of the vehicle and directs the air current toward the front windshield.

In this structure, the air current that flows into the passenger compartment along the front windshield and functions to defog the front windshield allows for the electrostatically charged atomized water droplets to reach deep into the vehicle occupant's hair.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing one embodiment of an in-vehicle compartment electrostatic atomization device according to the present invention;

FIG. 2 is a schematic diagram showing the in-vehicle compartment electrostatic atomization device installed in a vehicle;

FIG. 3 is a schematic cross-sectional diagram of the in-vehicle compartment electrostatic atomization device; and

FIG. 4 is a schematic perspective view showing a housing shared by an illumination device and the in-vehicle compartment electrostatic atomization device.

### DESCRIPTION OF EMBODIMENT

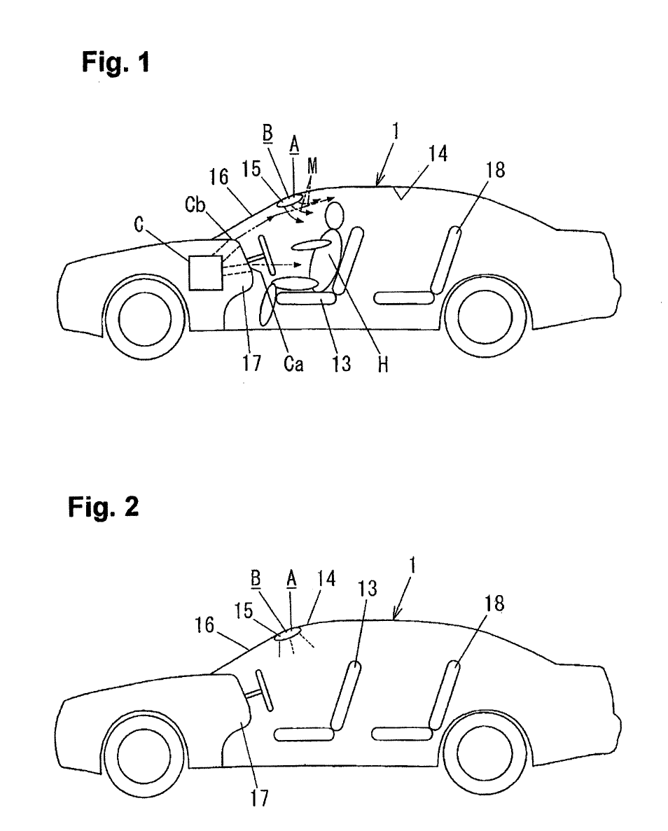

Referring to FIGS. 1 and 2, an in-vehicle compartment electrostatic atomization device A (hereinafter simply referred to as the electrostatic atomization device) is applied to a vehicle 1, such as an automobile. The electrostatic atomization device A generates electrostatically charged atomized water droplets M of nanometer size (also referred to as nano-size mist), which is discharged into the passenger compartment of the vehicle 1.

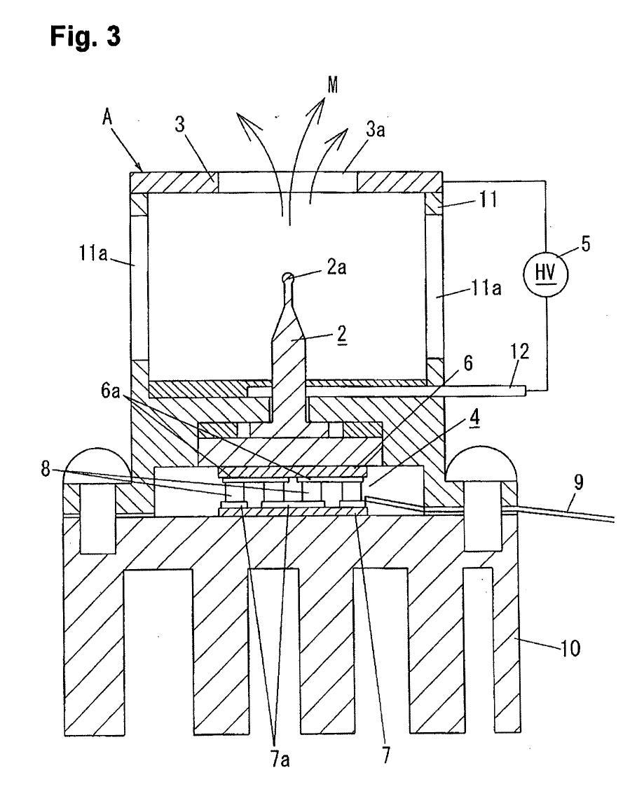

As shown in FIG. 3, the electrostatic atomization device A includes a discharge electrode 2, an opposed electrode 3, a water supply unit 4, and a high voltage application unit 5. The discharge electrode 2 is cylindrical and has a tapered end. The opposed electrode 3 faces toward a discharge portion 2a formed on the distal end of the discharge electrode 2. The water supply unit 4 supplies water to the discharge portion 2a. The high voltage application unit 5 is formed by a high voltage power supply and applies high voltage between the discharge portion 2a and the opposed electrode 3. By applying high voltage between the discharge portion 2a (discharge electrode) and the opposed electrode 3, the high voltage application unit 5 causes a corona discharge.

One example of a water supply unit 4 is a Peltier unit that cools the discharge electrode 2. The Peltier unit cools the moisture suspended in air to generate condensed water and provides the discharge electrode 2 with the water. The Peltier unit includes two Peltier circuit boards 6 and 7. The Peltier circuit boards 6 and 7 respectively include insulative plates and conductor patterns 6a and 7a. The insulative plates are formed from alumina or aluminum nitride, which have superior thermal conductivity. The Peltier circuit boards 6 and 7 are arranged so that the conductor patterns 6a and 7a face toward each other. A plurality of BiTe thermoelectric elements 8 are held between the two Peltier elements 6 and 7. The conductor patterns 6a and 7a of the two Peltier circuit boards 6 and 7 electrically connect adjacent ones of the thermoelectric elements 8. Current activating the Peltier unit flows through a lead line 9. Activation of the Peltier unit transfers the heat of one Peltier circuit board 6 to the other Peltier circuit board 7. The Peltier circuit board 6 is referred to as a cooling Peltier circuit board, and the other Peltier circuit board 7 is referred to as a heat radiation Peltier circuit board. The discharge electrode 2 is thermally coupled to the Peltier circuit board 6. Heat radiation fins 10 are connected to the Peltier circuit board 7.

The discharge electrode 2 is housed in a cylindrical tube 11, which is formed from an insulative material. The opposed electrode 3 is arranged on the distal surface (upper surface as viewed in FIG. 3) of the tube 11. The opposed electrode 3 is, for example, annular and has a central opening, which defines a mist discharge port 3a. In this manner, the discharge electrode 2 and the opposed electrode 3 face toward each other spaced apart by a predetermined distance. In the illustrated example, the center of the mist discharge port 3a in the opposed electrode 3 is aligned with the axis of the discharge electrode 2. A plurality of vents are formed in the cylindrical wall of the tube 11. The vents 11a are in communication with the mist discharge port 3a of the opposed electrode 3 through the interior of the tube 11.

A high voltage lead line 12, which is electrically connected to the discharge electrode 2, extends through the circumferential wall of the tube 11. The high voltage application unit 5 applies high voltage between the high voltage lead line 12 and the opposed electrode 3 so that the discharge electrode 2 has negative polarity. In this manner, high voltage is applied between the discharge portion 2a and the opposed electrode 3.

Activation of the Peltier unit cools the discharge electrode 2 and, condenses the moisture suspended in the air so that water (condensed water) forms on the surface of the discharge portion 2a. In this state, the application of high voltage between the discharge electrode 2 and the opposed electrode 3 results in water, which is separated from the surface of the discharge portion 2a when released from surface tension, undergoing repetitive breaking and scattering (Raleigh fission). This generates a large amount of electrostatically charged atomized water droplets M, which are of nanometer size and which are negatively charged. The generated electrostatically charged atomized water droplets M are discharged out of the mist discharge port 3a in the opposed electrode 3, which is arranged at the distal open surface of the tube 11.

As shown in FIG. 2, the electrostatic atomization device A is retained in a housing 15 for an illumination device B, which is arranged in the ceiling 14 above the front seat 13 in the passenger compartment. The illumination device B is arranged so as to be located frontward (toward the front windshield) from the head of a vehicle occupant H (refer to FIG. 1) when the vehicle occupant H is seated on the front seat 13.

In a normal vehicle, an illumination device B (so-called map lamp) is installed in the ceiling 14 above the front seat 13 in the passenger compartment to provide illumination for a vehicle occupant H seated in the front seat 13 (driver seated in the driver seat or passenger seated in the front passenger seat). In this embodiment, the housing 15 of the illumination device B is shared by the electrostatic atomization device A. In other words, the electrostatic atomization device A includes the housing 15, which is formed integrally with the illumination device B.

In the example of FIG. 1, the electrostatic atomization device A is arranged so that the mist discharge port 3a is directed into the passenger compartment (downward). This efficiently discharges the electrostatically charged atomized water droplets M from the housing 15 into the passenger compartment.

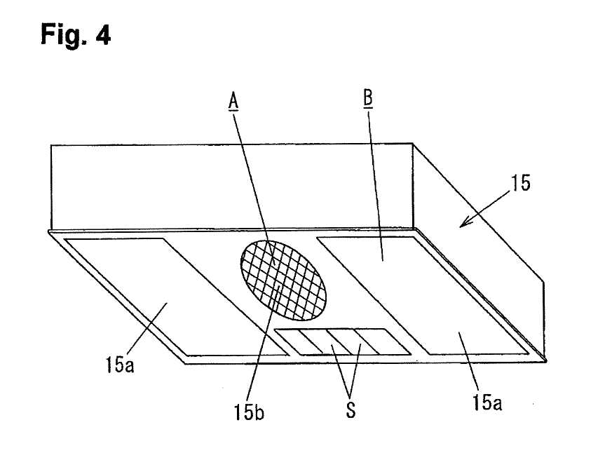

Referring to FIG. 4, the housing 15 is, for example, generally box-shaped. The housing 15 has a lower surface. Two light windows 15a are formed in the left and right sides of the lower surface of the housing 15. Illumination light of the illumination device B is emitted from the light windows 15a. A mist window 15b is formed between the two light windows 15a in the lower surface of the housing 15. Electrostatically charged atomized water droplets M is discharged from the mist window 15b. The light source of the illumination device B may be, for example, a light-emitting diode (LED). The use of an LED minimizes the space occupied by the illumination device B in the housing 15 so that the housing 15 may be shared by the illumination device B and the electrostatic atomization device A. This also suppresses enlargement of the housing 15. The housing 15 is received in a gap formed above the ceiling through an opening formed in a ceiling member (ceiling liner) for attachment to the ceiling 14 in the passenger compartment.

In the illustrated example, a switch S for starting and stopping operation of the electrostatic atomization device A is arranged on the housing 15 together with a switch S for turning on and off the illumination device B. The switches S do not have to be arranged on the housing 15, and switches (not shown) may be arranged on the dashboard 17 instead to operate the electrostatic atomization device A or illumination device B. Further, the electrostatic atomization device A may be operated in a manual control mode, in which the electrostatic atomization device A is controlled in accordance with the operation of the switches S on the housing or the switches on the dashboard, or an automatic control mode, in which the electrostatic atomization device A is controlled in accordance with detection signals from sensors (not shown) arranged in various parts of the vehicle 1. The sensors may include a sensor that detects the temperature and humidity in the passenger compartment, a sensor that detects the presence of a person in the passenger compartment, and a sensor that detects an odor in the passenger compartment. When operated in the automatic control mode, the sensor detection signals are used to automatically determine whether or not to activate the electrostatic atomization device A.

Power for the electrostatic atomization device A and the illumination device B may be directly supplied from the battery of the vehicle 1 or through a line extending from the ignition line. If power is supplied from the vehicle battery, the electrostatic atomization device A and the illumination device B are activated regardless of whether the ignition switch is on or off. If power is supplied from a line extending from the ignition line, the illumination device B is activated only when the ignition switch is on.

As described above, the electrostatic atomization device A of this embodiment is arranged near the head of a vehicle occupant H seated in the front seat 13. This drastically increases the amount of electrostatically charged atomized water droplets M from the electrostatic atomization device A that reaches the vehicle occupant's H hair. Thus, the effect of the electrostatically charged atomized water droplets M for improving the quality of human hair to a healthier state (improvement of flexibility, tensility, lustrousness, etc.) is enhanced. In addition, the portion of the ceiling 14 in the passenger compartment at which the illumination device B is located includes power lines connected to the illumination device B from the beginning. Further, this location includes enough space so as to allow for the arrangement of the illumination device B. Thus, the electrostatic atomization device A may be attached to the ceiling 14 without drastic design changes to the vehicle 1. Space is normally provided above the ceiling 14 (above the ceiling liner). This allows for part of the housing 15 to be received in the space formed above the ceiling 14 to decrease the amount the housing 15 projects into the passenger compartment from the housing 15.

As shown in FIG. 1, the vehicle 1 also includes a vehicle air conditioner C for heating and cooling the passenger compartment. The air conditioner C functions as an air current generation device which generates an air current in the passenger compartment.

Air outlets Ca and Cb of the air conditioner C are arranged in the dashboard 17 in front of the front seat in the passenger compartment. Activation of the air conditioner C discharges air from the air outlets Ca and Cb and generates an air current in the passenger compartment. The air outlet Ca located in the front surface of the dashboard 17 is directed toward the passenger occupant H who is seated on the front seat 13 facing toward the dashboard 17. The air outlet Cb located in the upper surface of the dashboard 17 is directed toward the front windshield 16. Operation of the switches arranged on the dashboard 17 enable air to be discharged from the selected one of the air outlets Ca and Cb.

The air outlet Ca located in the front surface of the dashboard 17 generates an air current (shown by double-dashed line) directed toward the body of the vehicle occupant H. The air outlet Cb located in the upper surface of the dashboard 17 generates an air current (shown by double-dashed line) directed toward the inner surface (into the passenger compartment) of the front windshield 16. Generally, the air current from the air outlet Cb located in the upper surface of the dashboard 17 functions to defog the front windshield 16 when flowing along the inner surface of the front windshield 16. The air conditioning mode in which the air conditioner C discharges air out of the upper surface of the dashboard 17 is thus referred to as a defroster mode. A typical vehicle is provided with the air conditioner C that is operable in the defroster mode.

When the air conditioner C is operating in the defroster mode, as shown in FIG. 1, an air current flows from the air outlet Cb, which is located in front of the front seat 13. Thus, the electrostatic atomization device A, which is attached to the ceiling 14 above the front seat 13, is located above the path of the air current. As a result, when the air conditioner C is operating in the defroster mode, the electrostatic atomization device A uses the air current generated by the air conditioner C so as to ensure that the electrostatically charged atomized water droplets M reaches the vehicle occupant's H hair.

In summary, the air stream produced in the defroster mode and shown in FIG. 1 carries the electrostatically charged atomized water droplets M generated by the electrostatic atomization device A toward the rear along the ceiling 14 in the passenger compartment. Thus, the electrostatically charged atomized water droplets M collect not only on the surface of the vehicle occupant's H hair but entirely in the vehicle occupant's H hair. This is advantageous in that the hair quality improvement effect of the electrostatically charged atomized water droplets M is further enhanced. Further, the air current also carries the electrostatically charged atomized water droplets M to the rear seat 18. Thus, when a vehicle occupant is seated on the rear seat 18, the effect for improving the hair quality of a vehicle occupant seated on the rear seat 18 may also be obtained.

The present examples and embodiments are to be considered as illustrative and not restrictive, and the invention is not to be limited to the details given herein, but may be modified within the scope and equivalence of the appended claims.

1. An in-vehicle compartment electrostatic atomization device arranged in a passenger compartment of a vehicle, the in-vehicle compartment electrostatic atomization device comprising:
a water supply unit for supplying water;
a discharge electrode which applies high voltage to water supplied from the water supply unit to electrostatically atomize the water and generate electrostatically charged atomized water droplets; and
a housing formed integrally with an illumination device arranged in a ceiling of the passenger compartment above a front seat of the vehicle.

2. The in-vehicle compartment electrostatic atomization device according to claim 1, wherein:
the vehicle includes an air current generation device which generates an air current flowing toward the rear along the ceiling in the passenger compartment from an air outlet arranged in front of the front seat; and
the housing is arranged toward the rear of the air outlet of the air current generation device in a path of the air current.

3. The in-vehicle compartment electrostatic atomization device according to claim 2, wherein the air outlet of the air current generation device is located below a front windshield of the vehicle and directs the air current toward the front windshield.
